(19) United States
(12) Patent Application Publication
(10) Pub. No.: US 2021/0340390 A1
(43) Pub. Date: Nov. 4, 2021

(54) BIOCOMPATIBLE INK

(71) Applicant: Phoseon Technology, Inc., Hillsboro, OR (US)

(72) Inventors: Theresa Thompson, West Linn, OR (US); Scott Igl, Portland, OR (US)

(21) Appl. No.: 16/862,165

(22) Filed: Apr. 29, 2020

(51) Int. Cl. C09D 11/037; C09D 11/023; B41M 5/00; B41J 11/00

(52) U.S. Cl. CPC C09D 11/037; C09D 11/023; C08K 3/40; B41J 11/002; B41M 5/0023

(57) ABSTRACT

Biocompatible ink formulations are described herein. In one example, a biocompatible ink formulation includes an ink base and a biocompatible component that, when mixed with the ink base to form the biocompatible ink formulation and subject to curing via ultraviolet light, causes the biocompatible ink formulation to be white.

### FIELD

The present description relates generally to biocompatible ink formulations.

### BACKGROUND/SUMMARY

Titanium dioxide (TiO₂) is the current pigment of choice for printing white in both water-based and ultraviolet (UV) catalyzed printing inks. The advantage of TiO₂ is in providing a stable bright white with little yellowing or off coloration with time. TiO₂ is currently used as a food additive and thus TiO₂ based inks may be used in printing on food packaging. While the impetus was from France, the EU has moved to reclassify particulate TiO₂ as a suspected class II carcinogen by inhalation (EU regulation on classification, labelling, and packaging (CLP)). The new classification is scheduled to go into full effect Oct. 1, 2021. This move may preclude the use of TiO₂ in food and foreshadows tighter regulation of use of TiO₂ in printed food packaging.

The inventors herein have recognized the above-mentioned issues and provide alternative biocompatible white pigment formulations for printing ink herein to at least partially address them. In one example, a biocompatible ink formulation includes an ink base and a biocompatible component that, when mixed with the ink base to form the biocompatible ink formulation and subject to curing via ultraviolet light, causes the biocompatible ink formulation to be white.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWING

FIG. 1 shows a biocompatible ink printed on an object according to embodiments of the disclosure.

FIG. 2 is a flow chart illustrating a method for printing with biocompatible ink, according to one or more embodiments of the disclosure.

### DETAILED DESCRIPTION

The present description is related to biocompatible ink formulations that may be used for printing on food labels, packaging, and/or other items that may be in close contact with food or where migration into food is a concern. Specifically, the biocompatible ink formulations described herein may be used to print in white, with little yellowing or off-coloration with time. For ink formulations, the key parameters for initial pigment assessment may include whiteness, opacity, and the ability to mix into an ultraviolet (UV) ink base. Beyond these characteristics, ink formulation becomes more complex as it begins to be tailored to specific uses and printing methods. For example, UV ink bases are organic chemical mixes, primarily acrylates and methacrylates.

There are multiple ways to achieve a white color in ink or paint. The first, and most common, is using a pigment. A second way to achieve white is to add air to reflect and refract the incident light (e.g., polar bear hair) or to suspend water crystals or bubbles in a matrix for the same effect (like the effect that results in white snow).

Pigment particle size is a known variable for ink production, with sizes of 200 micron or smaller needed to prevent clogging of ink printing jets. Particle sizes are also important for opacity of the ink, surface characteristics of the cured ink, and rheological characteristics such as particle suspension and viscosity.

An item of special consideration is that food safe additives tend to be water soluble and/or otherwise charged compounds. While powders can be directly added to the ink formulations, water, aqueous suspensions, and charged or polar compounds can present a formulation challenge when combining with organic mixtures such as those used for UV inks. For example, it may be difficult to achieve fine, uniform emulsions in ink (essentially a water in oil mixture). To address this problem of incorporating water and/or water soluble (i.e., charged or polar) compounds into an organic matrix, one or more emulsifying agents may be introduced as an admix to the ink base formulation. In keeping with the inert or food safe nature of the pigments, the emulsifying agents are also food safe or FDA approved food additives. These emulsifying agents allowed even mixing of the water soluble pigments (and indeed water) into the ink base. Use of the emulsifying agent(s) may aid in achieving an even white cured sample ink with the biologically compatible charged compounds.

As described herein, biocompatible white pigments that may be incorporated into a biocompatible ink formulation include water, MgSO₄, NaCl, potassium bitartrate, sodium bicarbonate, calcium carbonate, coconut oil, flour, non-fat dry milk, cornstarch, and polyvinyl acetate-based liquid glue. Each of these white pigments is biocompatible, has a particle size small enough to be used in ink jet printing, and does not disrupt UV-catalyzed curing of the ink. Further, each white pigment causes the ink to be white upon curing.

The biocompatible ink formulations described herein further include an ink base configured for use in UV-catalyzed curing. The ink bases that may be incorporated in the biocompatible ink formulations of the present disclosure are colorless upon curing, which helps facilitate a white ink when one of the biocompatible white pigments described above are mixed with the ink base, applied to a surface (e.g., printed), and cured. The ink base may include a first base component, alkoxylated hexanediol diacrylate monomer, and in some examples may further include a second base component, a mixture of acrylate oligomer, acrylate ester, and acrylic oligomer, mixed with the first base component. To facilitate emulsification when the white pigment is water-soluble, the ink base may include an emulsifying agent, such as sodium stearoyl lactylate (SSL). In an example, the ink base may include a mixture of the first base component and the second base component at a ratio of 9:1 v/v of the first base component to the second base component and 1 mg/100 μL of SSL in the ink base. This specific ink base may be colorless upon curing and the incorporation of SSL in the ink base may act as emulsifying agent and may also act as a photoinitiator, which may decrease the amount of curing time of the ink. The specific ink base used purposely does not contain a standard photoinitiator, such as Igacure™, in order to slow the curing in response to UV exposure making it easier to assess differences in curing and to more finely control exposure times (which translates directly to dose=time×irradiance) of the pigment ink base combinations.

The biocompatible ink formulations of the present disclosure may be cured using a suitable wavelength(s) of UV light, such as 395 nm or a dual exposure of 365 nm and 278 nm. Current photoinitiators (such as various benzophenones) are photoreactive at or near 395 nm, and many current presses utilize the 395 nm wavelength for UV curing. However, high irradiance shorter wavelengths, such as 278 nm and 365 nm, can cure the acrylate inks in the absence of photoinitiators (with concomitantly long exposures). Initial testing with acrylate oligomer and monomer mixtures (described herein) confirmed polymerization of the mixtures in the absence of a photoinitiator additive for the tested wavelengths. The biocompatible white pigments discussed herein may affect the curing of the ink, and thus different white pigments (when incorporated into the same ink base) may be cured using different curing times, such as 30 seconds, 10 seconds, five seconds, etc. It was expected that 278 nm exposure would result in a thin surface cure. Unexpectedly, the combination of 278 nm+365 nm in simultaneous exposure resulted in full cure of tested ink mixtures under conditions (irradiance at target and time of exposure) where exposure to a single 278 nm or 365 nm wavelength did not.

In order to identify the biocompatible white pigments, ink bases, curing properties, etc., various biocompatible inorganic and organic pigments were tested for use in biocompatible ink formulations, taking into consideration the key parameters for the pigment and for the ink formulation discussed above. Biocompatible pigments were identified that had sufficient whiteness, opacity, and the ability to mix into a UV ink base, and that were able to ground into a particle size small enough to prevent clogging of ink jet printers (e.g., 200 micron or smaller). Further, combinations of biocompatible pigment, UV ink base, and/or biocompatible emulsifying agents were identified that resulted in fine, uniform emulsions.

To perform the testing, various biocompatible pigment candidates were incorporated into different unpigmented ink bases, with an emulsifying agent in some examples, to generate a plurality of candidate biocompatible ink formulations. Each candidate biocompatible ink formulation was tested by applying each candidate biocompatible ink formulation to a surface and curing the candidate biocompatible ink formulation with different wavelengths of UV light. Each candidate biocompatible ink formulation was tested to assess the speed and level of curing, as well as whiteness upon curing.

### Materials

### Unpigmented Ink Base:

Components for mixtures of methacrylate oligomer+monomer, or oligomer+monomer+emulsifier:

1) Sartomer CN1000—<30-<60% Acrylate oligomer (proprietary); >10-30% Acrylate ester (proprietary); <0.5% proprietary component (proprietary); >30-60% Acrylic oligomer (proprietary). (Referred to in this document as CN1000.)

2) Sartomer CD564—Alkoxylated hexanediol diacrylate monomer. (Referred to in this document as CD564.)

3) Sodium stearoyl lactylate—a food safe emulsifier (CAS #25383-99-7, referred to in this document as SSL).

4) L-α-phosphatidyl choline—a food safe emulsifier (CAS #8002-43-5, referred to in this document as LPC).

5) 2-Hydroxyethyl cellulose—a food safe emulsifier (CAS #9004-62-0, referred to in this document as 2HEC)

### Pigmented Ink Base for Bluing Addition Experiment:

Miramer MNA857 (referred to in this document as MNA857)—a custom cyan pigmented ink base formulated without photoinitiators, from Miwon Specialty Chemical Company.

### Candidate Pigments and Whitening Compounds

Inorganic pigments:

1) Titanium dioxide (referred to as TiO₂ and used as a comparator), powder

2) Ground glass small sand sized crystals, still gritty to touch

3) MgSO₄—ground to a fine powder

4) NaCl—ground to a powder

5) Water

Organic pigments, small molecule:

1) Potassium bitartrate, powder

2) Sodium bicarbonate, powder

3) Calcium carbonate, ground to a powder

Organic pigments, large molecule:

1) Flour, powder (for the purposes of these examples the referenced flour is standard all-purpose, bleached, wheat flour; however, it is anticipated that any white flour (rice, tapioca, etc.) could be used as a pigment.)

2) Vegetable shortening (a blend of soybean oil, fully hydrogenated palm oil, and partially hydrogenated palm and soybean oils)

3) Coconut oil (virgin, white solid at room temperature)

4) Non-fat dry milk, ground to a fine powder

5) Cornstarch, powder

6) White Glue (polyvinyl acetate), liquid

### Light Sources

Phoseon 395 nm source used at a distance of 25 mm from lamp window to target.

Phoseon 278 nm source used at a distance of 25 mm from lamp window to target.**

Phoseon 365 nm source used at a distance of 25 mm from lamp window to target.**

**365 nm and 278 nm were used in simultaneous exposure.

### Tests to Assess Curing

Thumb twist test: Touch the cured surface with thumb, press lightly, and twist. If the ink appears on the thumb, then the surface is not cured.

Rub test: Rub the cured ink surface. If the ink rubs off onto the swab (pad or mechanical test), the ink is not cured.

Visual assessment: If ink is obviously still liquid, the ink is not cured.

### Tests to Assess Flexibility

Finger wrap: Ink samples (50 μL) were dotted onto a support (paper or aluminum foil) then cured for a final spot size of approximately 2 cm diameter. The cured ink+support is wrapped around the index finger. If the ink does not break or crack it is deemed flexible.

### Experiments/Examples

### Effect of Ink Base Formulation Color on Final Color of UV Polymerized White Ink

A preliminary test indicated that a mixture of TiO₂ with 90:10 CN100:CD564 was not bright white but rather a yellowed cream color (see composition 2 in Table 1, marked with an *). This suggested that a colorless base was necessary in order to achieve an acceptable white. Accordingly, different ratios of CN1000 to CD564 were assessed for color.

In order to achieve a true white, the supporting ink matrix should be as close to white or colorless as possible. The presence of yellow or another color was assessed by eye under fluorescent room lighting. Results of the color testing on different ratios of CN1000 to CD564 are shown in Table 1. Colorless or low color mixes were identified (compositions 6 and 7 of Table 1) and tested for polymerization. Polymerized samples were assessed for polymerization in 180 seconds or under when exposed to 278 nm+365 nm UV while maintaining a lack of yellow tint (by visual inspection). Further white pigment experiments used composition 6 (CN100:CD564 10%/90%) since composition 7 did not reliably polymerize and compositions 1 through 5 were visibly yellowed.

TABLE 1

| Composition | CN1000% | CD564% | | Further |
|---|---|---|---|---|
| # | (v/v) | (v/v) | Color | testing |
| 1 | 100 | 0 | Yellow | No |
| 2 | 90 | 10 | Yellow | No* |
| 3 | 70 | 30 | Less Yellow | No |
| 4 | 50 | 50 | Light Yellow | No |
| 5 | 30 | 70 | Tinge of yellow | No |
| 6 | 10 | 90 | Clear | Yes |
| 7 | 0 | 100 | Clear | Yes |

A preliminary test of composition 2+TiO₂ (*) resulted in a yellowed cream color rather than the bight white expected fromTiO₂. The yellowing was attributed to the ink base mixture composition. To test whether the presence of a blue pigment/bluing agent would compensate for a yellow ink base to turn it visually white, compositions 3-7 were assessed for color after adding MNA857 (1:3,136 and 1:1,596). The resulting mixtures of compositions 1 through 5 were less yellow but also slightly blue. Mixtures using bluing+compositions 6 or 7 were obviously blue. TiO₂ was added to 50 μL of each of the blued compositions 3-5 (e.g., each of compositions 3-5 mixed with MNA857), exposed to 365 nm+278 nm UV LED (1 W/cm² and 2 W/cm², respectively, at the lamp window) for 1 min from a distance of 25 mm. None of the TiO₂ mixes cured fully, and all mixtures showed some blue tint to the white. Accordingly, the bluing agent (e.g., MNA857) was determined to be insufficient to correct the yellowing. Hence, composition 6 (the clear mixture CN/CD 10%/90% v/v) was subsequently used for assessment of white pigments.

To incorporate the emulsifiers into the UV ink base, vortex mixing followed by sonication was utilized. The vortexing and sonication was repeated until an even distribution of emulsifier was present in the ink base. For example, to incorporate SSL into CN/CD 10%/90%, 6.4 mg SSL+640 μL CN/CD 10%/90% was mixed in an Eppendorf microfuge tube (at a ratio of 1 mg per 100 μL). Ranges of 0.1 mg to 2 mg per 100 μL were tested for incorporation into the UV ink base. SSL was difficult to incorporate into the mixture at concentrations greater than 1 mg per 100 pt. All concentrations could be incorporated into the CN/CD 10%/90%. The CN/CD 10%/90%+X mg SSL mixture was vortexed, followed by sonication (5 min at 37° C.), and this process was repeated as needed to reach a suspension. It is anticipated that the final ink (containing an emulsification agent such as SSL) will demand a specific mixing protocol to obtain the small droplet sizes characteristic of stable emulsions. Stable emulsions would be suitable for use in printing. Otherwise the mixture could demand periodic mixing to maintain the suspension of ink base, emulsifier, and pigment.

### Polymerization of Ink Base in the Absence of Pigment and Emulsifiers

The CN/CD 10%/90% v/v ink base (composition 6), CD564 100% (composition 7), and CN/CD 10%/90% v/v+SSL at 1 mg/100 μL ink base were each exposed to 365 nm+278 nm UV LED (1 W/cm² and 2 W/cm², respectively, at the lamp window) at a distance of 25 mm for various times to assess polymerization in the absence of pigment. Results of the cure test for each mixture at different curing times are shown in Table 2.

TABLE 2

| Mixture | Time (sec) | Cure Results |
|---|---|---|
| CN/CD 10%/90% v/v ink base | 10 | Clear, Not cured |
| | 30 | Clear, Not cured |
| | 60 | Clear |
| | 180 | Clear |
| CD564 100% | 10 | Clear, Not cured |
| | 30 | Clear, Not cured |
| | 60 | Clear |
| | 180 | Clear, Fully cured |
| CN/CD 10%/90% v/v + SSL | 10 | Clear, Not cured |
| at 1 mg/100 μL ink base | 30 | Clear, Not cured |
| | 60 | Clear |
| | 180 | Clear, Fully cured |

CN/CD 10%/90% v/v+SSL at 1 mg/100 μL ink base was exposed to 395 nm UV LED at 25 mm from lamp window to target for various times to assess polymerization in the absence of pigment, the results of which are shown in Table 3.

TABLE 3

| Mixture | Time (sec) | Cure Results |
|---|---|---|
| CN/CD 10%/90% v/v + SSL | 10 | Clear, Fully cured |
| at 1 mg/100 μL ink base | 5 | Clear, fully cured |

Based on the results shown in Tables 2 and 3, the incorporation of SSL has some photoinitiator activity at the combined 278 nm+365 nm wavelengths. For example, when SSL is included, the ink base cures more fully than when SSL is not included, suggesting photoinitiator activity (e.g., the ink base including SSL fully cured with an exposure of 180 seconds, while the same ink base without SSL did not fully cure with an exposure of 180 seconds). CN/CD 10%/90% v/v+SSL at 1 mg/100 μL ink base is referred to hereafter as the Master Mix. Both wavelength sets (395 nm or 365 nm+278 nm) can cure the Master Mix, and 30 seconds was identified as the initial exposure time for test of curing with 365 nm+278 nm. It was anticipated that some of the whitening agents might be sensitive to the curing wavelengths so shorter exposure was chosen as an initial test condition for purposes of safety during testing. For example, exposures to 365 nm+278 nm for longer than 90 seconds resulted in blackening and smoking of the ink mixtures that included non-fat dry milk powder. Pigments that required longer curing times were determined experimentally. Unexpectedly, many of the pigment mixtures cured in less than the 180 seconds expected from the cure testing to choose an ink base (Table 2). This indicates that the chosen white pigments have photoinitiator activity at the tested wavelengths, allowing them to perform dual function in ink mixtures as biocompatible white pigments and biocompatible photoinitiators. The same is not true for TiO₂, which did not fully cure with 365 nm+278 nm simultaneous exposure (Table 4).

### Pigment Color and Opacity

Table 4 shows the results of the cure tests performed on the inorganic pigments mixed with the Master Mix. All table information in Table 4 (as well as Tables 5 and 6) is given for the 365 nm+278 nm combination exposure. These wavelengths allowed easier exposure control for testing purposes. Results for 395 exposures were similar; however shorter exposure times were needed.

The inorganic pigments that were tested include TiO₂, glass, MgSO₄, NaCl, and water. TiO₂ did not fully cure before beginning to discolor. The bottom was not cured and the exposed mix failed the thumb test. Ground glass cured at 300 seconds but the cured ink was yellowed. 300 seconds is enough to cure this ink base in the absence of any photoinitiator. Ground glass at this large fragment size does not give an opaque pigment and does not yield a white cured ink, failing the assessment for use as a white pigment. MgSO₄ cured well and quickly. The cured MgSO₄ and Master Mix ink is white and translucent/transparent when the MgSO₄ is in crystal form. When the MgSO₄ was ground to powder with a mortar and pestle, the cured product is a nearly opaque white but with some sparkle. The cured ink is stiff and not flexible. NaCl fully cured and was white when used as a powder but still transmits light. If not powdered, the ink with NaCl cures but is mostly transparent. Water was added at an equal amount to the Master Mix (e.g., 20 μL water+20 μL Master Mix), vortexed to mix, then exposed to the UV light. Water resulted in white ink (e.g., the color of snow). The MgSO₄, NaCl, and water all have some degree of translucence and in instances where an opaque ink was needed, would require mixture with an additional compound to achieve an opaque flexible white ink.

White ink (TiO₂ pigment) is known to be difficult to cure and difficult to maintain in inks, and may require stirring to remain in suspension. In these tests (Table 4), titanium dioxide did not cure before discoloration began. Since TiO₂ is a polar molecule, the addition of an emulsifying agent (such as SSL or LPC) to the ink formulation should serve to stabilize the emulsion, as it can for other organic white pigments. An example is given in Table 9 of opaque mixtures including both MgSO₄ and Potassium bitartrate. The same principle applies to mixed pigments to achieve different ink capabilities which include opacity, flexibility, rheological characteristics, etc.

TABLE 4

| Compound | Wavelength(s) | Time (sec) | Results (color, cure) |
|---|---|---|---|
| Titanium dioxide | 365 nm + 278 nm | Various, | White opaque, not fully cured |
| (TiO₂, used as a | | 5-180 | at any time. Discoloration |
| comparator) | | | occurs after 180 sec. |
| Ground glass | 365 nm + 278 nm | 300 | Clear with brown yellow tint, |
| | | | Cured, inflexible |
| MgSO₄ | 365 nm + 278 nm | 30 | White nearly opaque with a |
| | | | sparkle, Cured and inflexible |
| NaCl | 365 nm + 278 nm | 30 | Whitish translucent, Cured |
| Water | 365 nm + 278 nm | 30 | White shimmery translucent, |
| | | | Cured and flexible |

Table 5 shows the results for the small molecule organic pigments cured in the Master Mix. Potassium bitartrate was shown to cure quickly and fully. The ratio of Master Mix to the pigment can be adjusted to obtain opacity. Sodium bicarbonate resulted in a cured ink that was very white but not completely opaque. The cured ink was easily released from an aluminum foil substrate and it did not adhere tightly to the foil backing. Calcium carbonate cured to a very white color. The ink was easily cured, i.e., noticeably cured prior to reaching the 30 second time point. Notably, calcium carbonate resulted in a stiff ink that can be cured as a three dimensional solid. As an example, a 2 mm high stiff mixture was cured.

TABLE 5

| Compound | Wavelength (s) | Time (sec) | Results (color, cure) |
|---|---|---|---|
| Potassium bitartrate | 365 nm + 278 nm | 30 | White very little light |
| (Cream of Tartar) | | | transmission, flat. Fully cured, |
| | | | stiff, adheres to substrate |
| Sodium bicarbonate | 365 nm + 278 nm | 30 | White semi-opaque. Fully |
| (Baking soda) | | | cured, some flexibility. |
| Calcium carbonate | 365 nm + 278 nm | 30 | White opaque flat. Not flexible. |
| (Chalk) | | | |

Table 6 shows the results for the large molecule and mixed molecule organic pigments cured in the Master Mix. The large molecule and mixed molecule organic pigments that were tested include all-purpose bleached white flour, vegetable shortening (which was soluble in the Master Mix and became clear on mixing), coconut oil (which was soluble in the Master Mix and became clear on mixing), non-fat dry milk powder, cornstarch, and white glue (e.g., 1:6 v/v with Master Mix).

TABLE 6

| Compound | Wavelength(s) | Time (sec) | Results (color, cure) |
|---|---|---|---|
| Flour (bleached) | 365 nm + 278 nm | 30 | Opaque white with a pale grey |
| | | | tint, cured and stiff |
| Crisco (veg. | 365 nm + 278 nm | 90 | Clear and transparent, Cured |
| shortening) | | | but emitted smoke, flexible |
| Coconut oil | 365 nm + 278 nm | 20 | Off white - cream color |
| | | | translucent/transparent, Cured |
| | | | but slick and flexible |
| Non-Fat Dry Milk | 365 nm + 278 nm | 60 | Opaque flat white, Fully |
| | | | cured, flexible |
| Corn Starch | 365 nm + 278 nm | 20 | Opaque white, fully cured and |
| | | | brittle |
| Glue (white liquid) | 365 nm + 278 nm | 30 | White, fully cured and flexible |

The large molecules are organic and subject to burning if UV exposure is excessive. Specific testing in the system where the pigment is used in printing in order to cure, without discoloration due to burn, may be needed for use of these compounds. While compounds such as Crisco and coconut oil are not suitable as white pigments, these larger molecules are anticipated to provide altered rheological characteristics to UV inks without increasing the time needed for cure.

The addition of pigments other than titanium dioxide can increase the cure speed of the ink. Non-fat dry milk does not fully cure in 30 sec using the Master Mix but does at 1 min. However, in combination with potassium bitartrate the cure is full (see below—Mixtures of pigment). Non-fat dry milk began to discolor (brown, likely due to the Maillard reaction) at times longer than 60 sec. Cornstarch began to fume at 20 sec so cure time was cut short. Due to the UV sensitivity as evidenced by fuming, cornstarch is considered to be of limited use as a pigment. Coconut oil was cut short at 20 seconds of total exposure. It was observed to emit fumes at this time and the exposure terminated.

### Ranges of Concentration Possible and Characteristics of Mixtures

All pigments were mixed into 90 μL of Master Mix for the tests below.

The mixtures for potassium bitartrate in master mix are shown in Table 8.

TABLE 8

| Compound | Amt (mg) | Wavelength(s) | Time (sec) | Results |
|---|---|---|---|---|
| Potassium bitartrate | 21.6 | 365 nm + 278 nm | 30 | White translucent. Bottom |
| | | | | cured, top incomplete. Some |
| | | | | flexibility |
| Potassium bitartrate | 40.9 | 365 nm + 278 nm | 30 | White translucent. Fully cured. |
| | | | | Not flexible. |
| Potassium bitartrate | 52.5 | 365 nm + 278 nm | 30 | White translucent. Fully cured. |
| | | | | Not flexible. |
| Potassium bitartrate | 51.5 | 395 nm | 10 | White translucent. Fully cured. |
| | | | | Not flexible. |

The mixtures for potassium bitartrate+MgSO₄ powder are shown in Table 9. The speed mix shown in Table 9 is 565.8 mg potassium bitartrate+44.8 mg MgSO₄ in 500 μL Master Mix. Each mixture was tested by applying 90 μL of the mixture on a foil target. The combination of Potassium bitartrate with MgSO₄ yields a bright white pigment that when exposed to 365 nm+278 nm UV becomes a similarly bright white translucent to opaque (depending on relative concentrations of the pigments) cured ink.

TABLE 9

| Compound | Amt (mg) | Wavelength(s) | Time (sec) | Results |
|---|---|---|---|---|
| Potassium | 12.5 + 12.2 | 365 nm + 278 nm | 30 | White translucent. Fully |
| bitartrate + MgSO₄ | | | | Cured. Not flexible. |
| Potassium | 25.8 + 31.2 | 365 nm + 278 nm | 30 | White translucent. Fully |
| bitartrate + MgSO₄ | | | | Cured. Not flexible. |
| Potassium | 55 + 53.7 | 365 nm + 278 nm | 30 | White less translucent. Fully |
| bitartrate + MgSO₄ | | | | Cured. Not flexible. |
| Potassium | 101.6 + 99.6 | 365 nm + 278 nm | 30 | Bright White very little |
| bitartrate + MgSO₄ | | | | translucence observed on a |
| | | | | black background. Fully |
| | | | | Cured. Not flexible. Gritty |
| | | | | surface texture. |
| Potassium | 141 + 10.7 | 365 nm + 278 nm | 30 | Bright White Opaque. Fully |
| bitartrate + MgSO₄ | | | | Cured. Not flexible. Not gritty. |
| Potassium | Speed mix | 365 nm + 278 nm | 5 | Bright White Opaque. Fully |
| bitartrate + MgSO₄ | | | | Cured. Not flexible. |
| Potassium | Speed mix | 365 nm + 278 nm | 1 | Bright White Opaque. Fully |
| bitartrate + MgSO₄ | | | | Cured. Not flexible. |

Titanium dioxide test cures are shown in Table 10. Titanium dioxide is commonly used as a white pigment for inks and paints. It provides a bright white pigment that is not toxic (unlike lead oxide routinely used until the 1970's). Titanium dioxide, along with Zinc oxide, is commonly used in UV protection ointments since the both block UVB and short wave UVA. Unfortunately, this UV blocking characteristic interferes with the curing of inks that rely on UV sensitive photoinitiators. On the positive side titanium dioxide pigment can provide a bright white, smooth flexible dry ink and is less toxic than lead pigments. However, the ink is difficult to cure due to its UV blocking characteristics and the titanium dioxide pigment may be difficult to keep in suspension between ink uses. Since most of the testing cited here used 278 nm+365 nm (UVC+UVA) wavelengths the disadvantages of titanium dioxide UV blocking were more apparent, showing up as the incomplete curing noted in Table 10. Note though, that since titanium dioxide is a polar molecule the use of an emulsifier (such as SSL or LPC) in the ink formulation may improve titanium dioxide's suspension characteristics.

A combination of TiO₂ with a second pigment can decrease time required for curing while maintaining opacity, white color, and flexibility. An example of improved curing characteristics for a mixture of pigments is shown in Table 10 where a combination of TiO₂ and potassium bitartrate was opaque white flexible and fully cured in under 30 seconds. It is understood that a combination may also allow a decrease in the concentration of TiO₂ used, and therefore the percent TiO₂ in an ink composition that contains a food safe (biocompatible) pigment, TiO₂, and a biocompatible emulsifying agent (such as SSL or LPC).

TABLE 10

| Compound | Amt (mg) | Wavelength(s) | Time (sec) | Results |
|---|---|---|---|---|
| TiO₂ | 24.6 | 365 nm + 278 nm | 10 | White opaque. Not cured. Gooey. |
| TiO₂ | 24.6 | 365 nm + 278 nm | 20 | Not cured - fails the thumb test. |
| | | | | Center is starting to discolor to |
| | | | | brown. |
| TiO₂ + Potassium | 16.6 + 9.3 | 365 nm + 278 nm | 20 | White opaque, Cured. Flexible. |
| bitartrate | | | | |

Calcium carbonate test cures are shown in Table 11. Calcium carbonate has previously been suggested as an extender for use with titanium dioxide in UV cured flexo ink at concentrations up to 20% replacement. The addition of a biocompatible emulsifying agent may improve the interaction of the pigment components resulting in a more even mixture. Also, the calcium carbonate+Master Mix cures to a rigid material that can be build up in 3 dimensions.

TABLE 11

| Compound | Amt (mg) | Wavelength(s) | Time (sec) | Results |
|---|---|---|---|---|
| Calcium carbonate | 26.3 | 365 nm + 278 nm | 30 | Cured, white translucent, |
| | | | | adheres to the foil target. |
| | | | | Slightly flexible. |
| Calcium carbonate | 50.7 | 365 nm + 278 nm | 30 | Cured, white translucent, |
| | | | | adheres to the foil target. Not |
| | | | | flexible. |
| Calcium carbonate | 155.6 | 365 nm + 278 nm | 30 | Cured, white opaque, 3D, |
| | | | | adheres to the foil target. Not |
| | | | | flexible/rigid. (Closer to |
| | | | | building material than ink.) |
| Calcium carbonate | 77.3 | 365 nm + 278 nm | 30 | Cured. White opaque, adheres |
| | | | | to the foil target. Not flexible |

Non-fat dry milk and Non-fat dry milk+Potassium bitartrate test cure results are shown in Table 12. The Non-fat dry milk+Potassium bitartrate pigment mixture is a further example of photoinitiator activity of the Potassium bitartrate. Adjustments of relative and absolute concentration of the two pigment components may allow adjustment of the formulation to suit various uses.

TABLE 12

| Compound | Amt (mg) | Wavelength(s) | Time (sec) | Results |
|---|---|---|---|---|
| Non-fat dry milk | 27.8 | 365 nm + 278 nm | 30 | Not Cured |
| Non-fat dry milk + | 52.1 + 50.7 | 365 nm + 278 nm | 30 | White creamy look, Opaque. |
| potassium bitartrate | | | | Warm to touch. Stiff not flexible. |

Thus, the testing described above identified potential white pigments for use in UV printing, expands the wavelengths that may be used for printing using white pigments beyond UVA alone (normally 395 nm), provides the option for use of food-safe emulsifiers to improve incorporation of food-safe pigments in UV cure ink formulations, provides food-safe alternative white pigments for food contact surfaces, and/or provides food-safe pigments. The white pigments identified herein are not limited to printing intended for food labeling or food contact and could be used in virtually any printing context. The approach described herein provides a framework for identifying other colors of biocompatible water soluble pigments suitable for incorporation in UV cured ink.

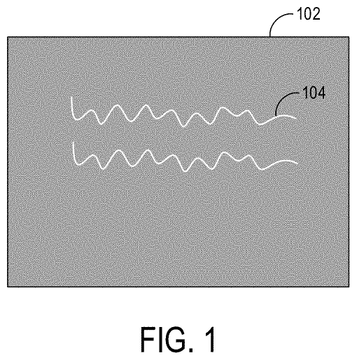

FIG. 1 schematically shows an example 100 of a biocompatible white ink formulation as described herein printed on an object. As shown in FIG. 1, an object 102 may be printed on with biocompatible ink 104. The object 102 may be a label, a bottle, a box, a food product (e.g., an apple), or another suitable object. The object 102 may be comprised of paper, plastic, wood, metal, organic material (e.g., food), other materials, or combinations thereof. The biocompatible ink 104 may include any of the formulations described herein. For example, the biocompatible ink may include an ink base and a biocompatible component that, when mixed with the ink base to form the biocompatible ink formulation and subject to curing via ultraviolet light, causes the biocompatible ink formulation to be white. The biocompatible component may include one or more of water, MgSO₄, NaCl, potassium bitartrate, sodium bicarbonate, calcium carbonate, coconut oil, flour, non-fat dry milk, cornstarch, and polyvinyl acetate-based liquid glue. The ink base may include a first base component and/or a second base component, the first base component including a mixture of acrylate oligomer, acrylate ester, and acrylic oligomer, the second base component including alkoxylated hexanediol diacrylate monomer, the first and second components at a ratio of 1:9 v/v. In some examples, the ink base further comprises a biocompatible emulsifying agent, such as sodium stearoyl lactylate. The biocompatible ink formulation may not include titanium dioxide, in some examples. In other examples, the ink formulation may include titanium dioxide (e.g., in addition to the biocompatible component) and a biocompatible emulsifying agent. In some examples, the biocompatible ink formulation does not include a separate photoinitiator (e.g., the biocompatible component may act as the photoinitiator). The ink may be cured via exposure to one or more wavelengths of UV light for a duration, such as 365 nm and/or 278 nm.

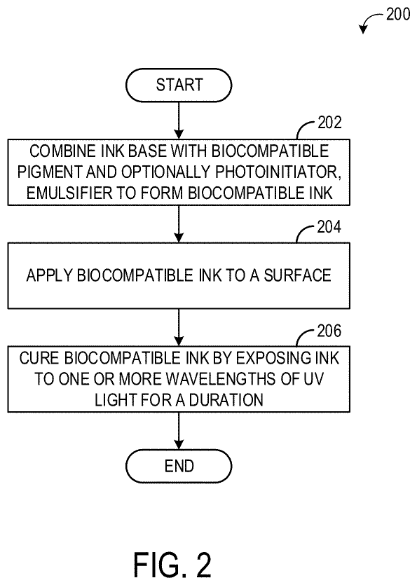

FIG. 2 shows an example method 200 for printing with a biocompatible ink. At 202, method 200 optionally includes combining an ink base with a biocompatible pigment to form a biocompatible ink. The ink base may be one of the ink bases described herein (e.g., a first base component including a mixture of acrylate oligomer, acrylate ester, and acrylic oligomer and a second base component including alkoxylated hexanediol diacrylate monomer, the first and second components at a ratio of 1:9 v/v) or other suitable ink base that is colorless or white and is compatible with UV curing. The biocompatible pigment may include one or more of water, MgSO₄, NaCl, potassium bitartrate, sodium bicarbonate, calcium carbonate, coconut oil, flour, non-fat dry milk, cornstarch, and polyvinyl acetate-based liquid glue. In some examples, a separate photoinitiator may be added. Likewise, an emulsifying agent (e.g., sodium stearoyl lactylate) may optionally be added. The biocompatible ink may be mixed (e.g., vortexed and/or sonicated) as described herein to form a stable formulation.

At 204, method 200 includes applying the biocompatible ink to a surface. The surface may be any suitable surface, as described above with respect to FIG. 1. The biocompatible ink may be applied via a suitable printer. At 206, the biocompatible ink is cured by exposing the biocompatible ink/surface to one or more wavelengths of UV light for a duration. The one or more wavelengths of light may depend on the specific biocompatible ink, and may include one or more of 365 nm and/or 278 nm. The duration may also depend on the specific biocompatible ink, as explained above.

Thus, as described herein biocompatible pigments may be incorporated into UV ink bases, and food-safe emulsifiers may be used to incorporate water soluble compounds into the organic (water insoluble) UV ink base. Multiple wavelengths may be applied to cure the white ink. White pigments described here (including Potassium bitartrate, Calcium carbonate, MgSO₄, etc.) may act as photoinitiators with the 365 nm+278 nm combination exposure. Further, emulsifiers and water may be incorporated into a UV ink base to produce a white ink in the absence of traditional white pigment. Potassium bitartrate (or other white pigments in this disclosure) may be used with TiO₂ to improve the white ink curing (e.g., for use in non-food contact printing).

This concludes the description. The reading of it by those skilled in the art would bring to mind many alterations and modifications without departing from the spirit and the scope of the description. For example, lighting sources producing different wavelengths of light may take advantage of the present description.

1. A biocompatible ink formulation, comprising:
an ink base; and
a biocompatible component that, when mixed with the ink base to form the biocompatible ink formulation and subject to curing via ultraviolet light, causes the biocompatible ink formulation to be white.

2. The biocompatible ink formulation of claim 1, wherein the biocompatible component comprises one or more of water, MgSO₄, NaCl, potassium bitartrate, sodium bicarbonate, calcium carbonate, coconut oil, flour, non-fat dry milk, cornstarch, and polyvinyl acetate-based liquid glue.

3. The biocompatible ink formulation of claim 2, wherein the ink base further comprises a biocompatible emulsifying agent.

4. The biocompatible ink formulation of claim 2, wherein the biocompatible emulsifying agent comprises sodium stearoyl lactylate.

5. The biocompatible ink formulation of claim 2, wherein the biocompatible ink formulation does not include titanium dioxide.

6. The biocompatible ink formulation of claim 2, further comprising titanium dioxide and a biocompatible emulsifying agent.

7. The biocompatible ink formulation of claim 1, wherein the biocompatible ink formulation does not include a separate photoinitiator.

8. The biocompatible ink formulation of claim 1, wherein the ink base comprises a first base component and/or a second base component, the first base component comprising a mixture of acrylate oligomer, acrylate ester, and acrylic oligomer, the second base component comprising alkoxylated hexanediol diacrylate monomer.

9. The biocompatible ink formulation of claim 8, wherein the ink base comprises the first base component and the second base component at a ratio of 1:9 v/v.

10. A method for printing with a biocompatible ink, comprising:
applying the biocompatible ink to a surface, the biocompatible ink comprising a biocompatible white pigment and an ink base;
curing the biocompatible ink on the surface by exposing the biocompatible ink to one or more wavelengths of ultraviolet (UV) light for a duration.

11. The method of claim 10, wherein the one or more wavelengths comprise 278 nm and 365 nm.

12. The method of claim 10, wherein the one or more wavelengths comprise 395 nm.

13. The method of claim 10, wherein the biocompatible white pigment comprises one or more of water, MgSO₄, NaCl, potassium bitartrate, sodium bicarbonate, calcium carbonate, coconut oil, flour, non-fat dry milk, cornstarch, and polyvinyl acetate-based liquid glue.

14. A biocompatible ink for UV-catalyzed printing, comprising:
a water-soluble, biocompatible white pigment;
an organic ink base; and a biocompatible emulsifying agent.

15. The biocompatible ink of claim 14, wherein the biocompatible white pigment comprises one or more of MgSO₄, NaCl, potassium bitartrate, sodium bicarbonate, and calcium carbonate.

16. The biocompatible ink of claim 14, wherein the biocompatible emulsifying agent comprises sodium stearoyl lactylate.

17. The biocompatible ink of claim 14, wherein the ink base comprises a first base component and/or a second base component, the first base component comprising a mixture of acrylate oligomer, acrylate ester, and acrylic oligomer, the second base component comprising alkoxylated hexanediol diacrylate monomer.

18. The biocompatible ink of claim 14, wherein the biocompatible ink does not include a separate photoinitiator.

19. The biocompatible ink of claim 14, wherein the biocompatible ink does not include titanium dioxide.

20. The biocompatible ink of claim 14, further comprising titanium dioxide.
